(19) United States
(12) Patent Application Publication
(10) Pub. No.: US 2007/0266938 A1
(43) Pub. Date: Nov. 22, 2007

(54) Device for Holding Components

(75) Inventor: Angelika Wolfer, Mainz (DE)

Correspondence Address: BIRCH STEWART KOLASCH & BIRCH, PO BOX 747, FALLS CHURCH, VA, 22040-0747, US

(73) Assignee: Der Greifer Limited, Mainz (DE)

(21) Appl. No.: 11/658,741

(22) PCT Filed: Dec. 29, 2004
(86) PCT No.: PCT/DE04/02835

§ 371 Date: Mar. 16, 2007

(30) Foreign Application Priority Data
Jul. 29, 2004 (DE) 10 2004 036 919.4

(51) Int. Cl. B05C 13/02

(52) U.S. Cl. 118/503

(57) ABSTRACT

The invention relates to a device for holding components (1), particularly bumpers and impact bars of motor vehicles, particularly for the purpose of painting, comprising a frame (2), said frame (2) having holding means on the top side thereof and these holding means, in turn, having a supporting part (3) with a cantilever structure (4) and two holding arms (5) projecting therefrom. The aim of the invention is to improve the treatment of the component, the adapting of the device the component and the positioning of the component while making an ergonomically favorable working position possible. To this end, the holding arms (5) have sections (6 to 9), which are joined to one another in an articulated and/or rotational manner, and the component (1), during operation of the device, is supported on the free end of the cantilever structure (4) and on the holding arms (5).

The present invention concerns a device for holding components, particularly bumpers and impact bars of motor vehicles, particularly for the purpose of painting, having a frame, wherein the frame includes holding means on the top side with a supporting part and with a cantilever structure and two holding arms projecting therefrom.

In practical application, components such as bumpers and impact bars of motor vehicle are customarily placed on a painting rack for the application of spray paint. Although holding means in the form of two support points do make it possible to hold the bumper and paint the top and bottom sides, this system is beset by multiple disadvantages. First of all, deformation of the overhanging bumper parts pointing away from the support points can take place because of the temperature treatment for the paint, and because of the support at only two support points. Secondly, the painter must assume a posture that is ergonomically very unfavorable when he paints the underside of the bumper resting on the painting rack under discussion. Furthermore, the stability of the painting rack is relatively poor.

Another paint stand is described in DE 202 19 107 U1. Object holders are attached to the crossbar of the supporting frame by means of clamping elements. As a result, the rod-like object holders can be moved in the transverse and/or longitudinal directions with respect to the crossbar and can be matched to the shape of the car body part to be placed on them. The component is held in position by stop pieces on the ends of the object holders. In this way, such components as a car door, for example, can even be held in an inclined position for painting. The prior art paint stand is suitable for components with large surface areas, and its stability comes from object holders having stop pieces and projecting from both sides of the crossbar. Narrow car body parts, such as bumpers or the like, cannot be painted on the prior art paint stand, since the crossbar would be in the way of painting the underside of the bumper or the like when it is supported in a stable way. In addition, the stability of this paint stand must be considered low; support remains the fundamental principle.

Another paint stand is known from DE 201 02 544 U1. This document describes a paint stand upon which are placed panels and doors for painting. Extending from a supporting part, at right angles to the supporting part and diametrically [opposed], are two cantilever structures. Projecting from each of the cantilever structures are two holding arms, which have a support function. The four support arms are frictionally connected in pairs by coupling mechanisms and can be moved synchronously to various adjustment positions—always in the horizontal support position. This system only provides a support option for large-area components with simple geometries, and the smaller the width dimension becomes, the more difficult treatment from below becomes.

From AT 398 391 B is known a supporting stand with supporting holders on brackets. Although the brackets can be rotated as a whole, they are otherwise unchangeable.

U.S. Pat. No. 5,164,011 concerns a fixture for the painting of doors. The frame there has holding arms at the top and bottom, with a downward or upward pointing pin provided on each arm. The door extends between the two pins.

The German utility model G 86 28 425.8 relates to a three-axis workpiece positioning device with a work arm on a standard and, at the end of the work arm, a clamping plate for chucking the workpiece.

From German utility model G 85 09 647.4 is known a device for holding a frame, known as a window casement holder. Located on a base frame is a column with a moveable carriage thereon, upon which is provided a rigid boom which extends perpendicular to the column and bears a suction head for attachment by suction of a panel element of the frame.

A similar device is known from German utility model G 82 35 367.0, which likewise concerns a window casement holder. A column having a boom with a suction head is provided there as well. On the column and suction head sides, the boom has two pivoting sections. The pivotability of the sections has the sole purpose of ensuring that all sides of the frame can be treated, but does not serve the purpose of adapting to the shape of the component to be treated.

Proceeding from the basis of the paint stand known from DE 201 02 544 U1, the object of the invention is to specify a device of the type under discussion with improved treatment options for the component. In particular, the desire was to permit adaptation of the device to the component, and positioning of the component, in order to allow ergonomically favorable workpiece-holding.

The above object is attained by the features of claim 1. According thereto, a device of the type under discussion is further developed such that the holding arms have sections that are articulated and/or are rotatably connected to one another, and in that the component in the operating position is supported on the free end of the cantilever structure and on the holding arms.

Proceeding from the prior art known from DE 201 02 544 U1, it was recognized, firstly, that it provided only a solution for large-area [flat] components to rest upon. It was further recognized that merely resting the component on a support is not very stable, and hinders treatment when the geometry of the component deviates from a flat [large-area] shape, in particular is three-dimensional, and thus cannot be laid down in a stable manner.

It has been recognized in accordance with the invention that the ability to treat the component can be improved when holding means are used that can be adapted to the component, in particular to an impact bar or a bumper, and also permit positioning of the component at various angles. Adaptation to the component, and also holding in certain ergonomically favorable positions, can be implemented by holding arms which can be adjusted to the geometric circumstances of the component and to the desired accessibility by means of various sections connected to one another in an articulated and/or rotatable manner. As a result of the special design of the holding arms and their adaptability, the component—especially when it is a bumper or impact bar—can be held in a position corresponding to its positioning on the motor vehicle, for example. Good accessibility of the component, including on its underside, is achieved by the special design of the holding arms. The usually downward-facing underside of a component, in the form of a bumper or impact bar, is advantageously fixed in a position accessible from the side, for example, in the inventive device. The various sections of the holding arms permit various holding points that go beyond merely resting on the support. A three-dimensional component in the form of a bumper may, for example, extend around the holding arms. The stability of the device is achieved to a significant degree by the cantilever structure, which provides at its free end an option for a part of the component to rest upon it, and which bears the majority of the load of the component and transmits it to the frame.

In a particularly advantageous manner, the invention is further developed in that the component is secured to the holding arms and/or to the cantilever structure. This can be achieved through fastening means that establish a connection to the component. This achieves a retention in position that simplifies the mechanical treatment steps such as filling, sanding and polishing that precede or follow the painting itself. If one arranges the fastening means in areas that permit access to the free ends of an elongated component, in particular a bumper, a deformation of the component during the spray application of temperature-controlled paint can advantageously be counteracted.

The cantilever structure could have essentially a U-shape viewed from above. This achieves the result that a three-dimensionally elongated component can, in a sense, extend around the cantilever. In order to increase the stability of the cantilever structure with regard to the geometry of a component with a relatively large lengthwise dimension, it is useful to design the base part of the U-shaped cantilever structure to be longer than the arms of the U-shape. Alternatively, a C-shape could also be used, or the base part of the U-shape could itself have a stability-enhancing planar shape instead of a linear shape. In further development, fastening means that attach the component to the cantilever structure could be provided on the base part. The fastening means could be present in the form of at least one or more holding vises, known per se, separated from one another, that are welded onto the cantilever structure or are supported thereon in a movable and lockable manner. The holding arms engage the arms of the U-shape at a distance from the base part, since the base part constitutes the free end. It is advantageous for the holding arms [to be] at a short distance from the supporting part that supports the cantilever structure.

An especially preferred embodiment of the inventive device provides for associating with the supporting part a frame which has a rotatable cross-member. Such a frame is already known in and of itself, and offers the advantage of pivoting the supporting part as a whole, including the component, about the axis of the cross-member, thus promoting the accessibility of the component. The supporting part could be connected to the cross-member of the frame in a releasable manner. Specifically, the releasable connection could be provided as a plug-in connection by means of receptacles on the supporting part and mounts on the cross-member.

The cantilever structure could in principle extend approximately perpendicular to the receptacles of the supporting part and be welded thereto, for example. With regard to a small packaging volume in view of an advantageous kit form for the inventive device, a releasable connection of the cantilever structure with the receptacles is preferred. The releasable connection could be implemented by a screw connection, a snap-in connection, or a bayonet connection, for example.

The holding arms of the inventive device could be associated with the cantilever structure. So that the entire length of the component can be gripped and held, each holding arm could be arranged on one arm of the U-shape of the cantilever structure, and extend in an essentially opposite direction.

An especially advantageous embodiment of the inventive device oriented toward the treatment of bumpers and impact bars of motor vehicles provides that one holding arm includes four tubular sections, said sections being rotatable and/or telescoping and lockable in suitable positions. The four sections could achieve an overall length of approximately 0.7 m in the non-extended position. Together with the length of the base part of the U-shaped cantilever structure, measuring approximately 0.5 m, an extendable total length of approximately 2.9 m would result, with the two holding arms having multiple degrees of freedom in their movability, and thus being variably adjustable in three dimensions and able to be adapted to the geometry of the component. The number of sections could also be larger or smaller, depending on the geometry of the component.

In the aforementioned embodiment of the inventive device oriented toward the treatment of bumpers and impact bars of motor vehicles, with four sections per holding arm, the design solution described below has proven to be advantageous.

Firstly, the first section of the holding arm is articulated to the cantilever structure, is rotatable about an axis of rotation perpendicular to the cantilever structure, and can be locked in a desired angular position. The second section of the holding arm is connected to the first section through an internal part. The internal part could have one end projecting into the first section and the other end extending into the second section, and permit a length adjustment through movability relative to the two sections between a zero position and a maximum position. In the zero position, the internal part could be located entirely inside the two sections. Moreover, the internal part could be rotatable about its longitudinal axis and lockable in a desired angular position. To this end, it is advantageous for the internal part to be present as a round tube, so that continuous rotation inside the first and second sections can take place and jamming is precluded. In addition to the variant described above, wherein the internal part is rotatable and telescoping relative to both the first and second sections, other designs are also possible which implement the rotary motion and the sliding or telescoping motion with a fixed internal part and a section that is movable in such a manner. In any case, the preferred embodiment permits a relatively large change in the length of the holding arm by doubling the length of the first and second sections as a result of sliding out the internal part.

The third section of the holding arm adjoins the end of the second section opposite the first section; the third section is articulated to the second section, is rotatable about an axis perpendicular to the second section, and can be locked in a desired angular position. Lastly, the fourth section of the holding arm is articulated to the third section, is rotatable about an axis perpendicular to the third section, and can be locked in a desired angular position.

To expand the holding and support function of the holding arm, the fourth section of the holding arm could have fastening means at its free end that permit a connection to the component. The fastening means could be present in the form of a holding vise or clamp that is plugged into the fourth section and is rotatable about its longitudinal axis. If applicable, a locking of the holding vise in the required angular position could also take place.

Link joints could be provided for the articulated connections of the sections of the holding arms, wherein the axes of rotation can be formed by wing screws that constitute locking means at the same time. Other joint types are also possible in place of link joints, in particular ball joints, as well as other connecting technologies that permit a rotary motion.

With regard to the optimal resting of the component on the cantilever structure and the sections of the holding arms, the arms could be made of square tubing material. Profiling or rubber coating of the surface would be possible, especially in the region of the contact surfaces for the component.

With regard to space-saving packaging, it is of particular advantage for the inventive device to be available as a kit. The supporting part, in particular the receptacles, the cantilever structure, and the holding arms, and if applicable their individual sections, could be parts of this kit and be assembled by the user with the aid of instructions.

There are a variety of possible ways to advantageously embody and further develop the teaching of the present invention. In this regard, reference is made, firstly, to the dependent claims of claim 1, and secondly, to the following explanation of an example embodiment of the invention on the basis of the drawing. In conjunction with the explanation of the example embodiment of the invention shown, generally preferred embodiments and further developments of the teaching are also explained. The drawings show:

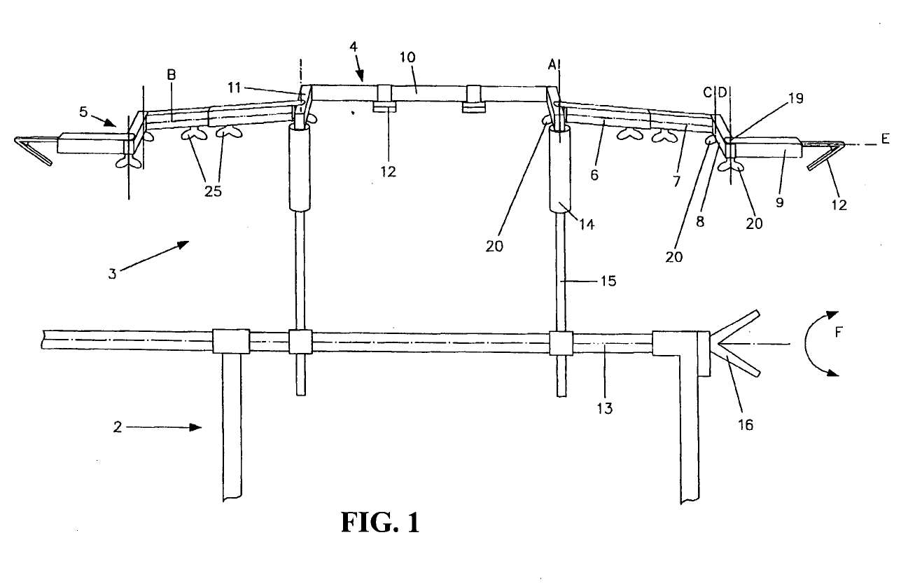

FIG. 1 the inventive device in a schematic, perspective representation,

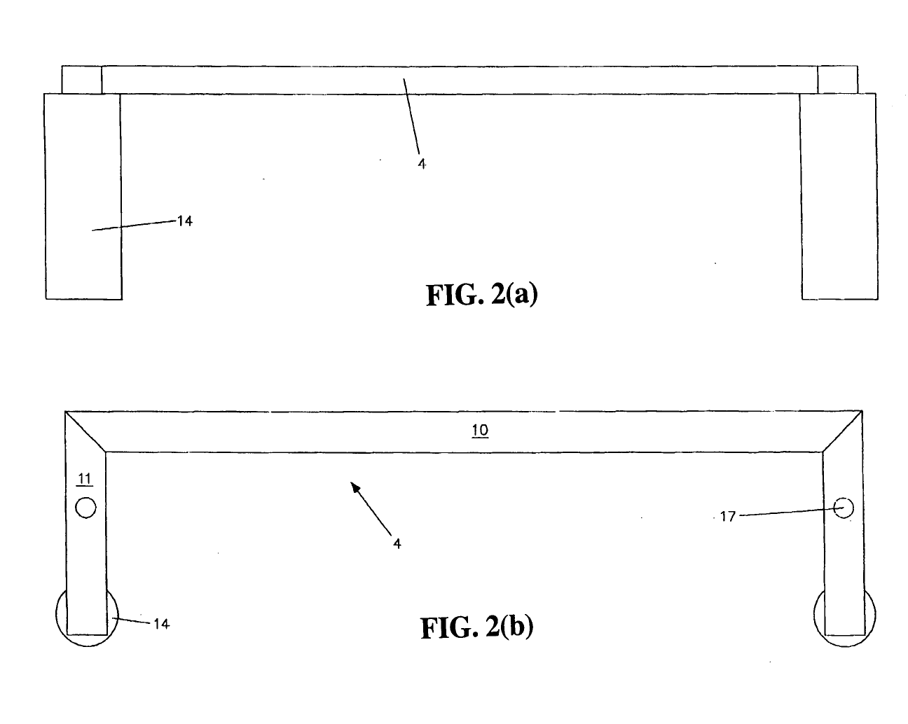

FIG. 2 schematic representations of

a) an enlarged front view of a detail from FIG. 1, relating to the cantilever structure and the receptacles, and

b) an enlarged top view of a detail from FIG. 1, relating to the cantilever structure and the receptacles,

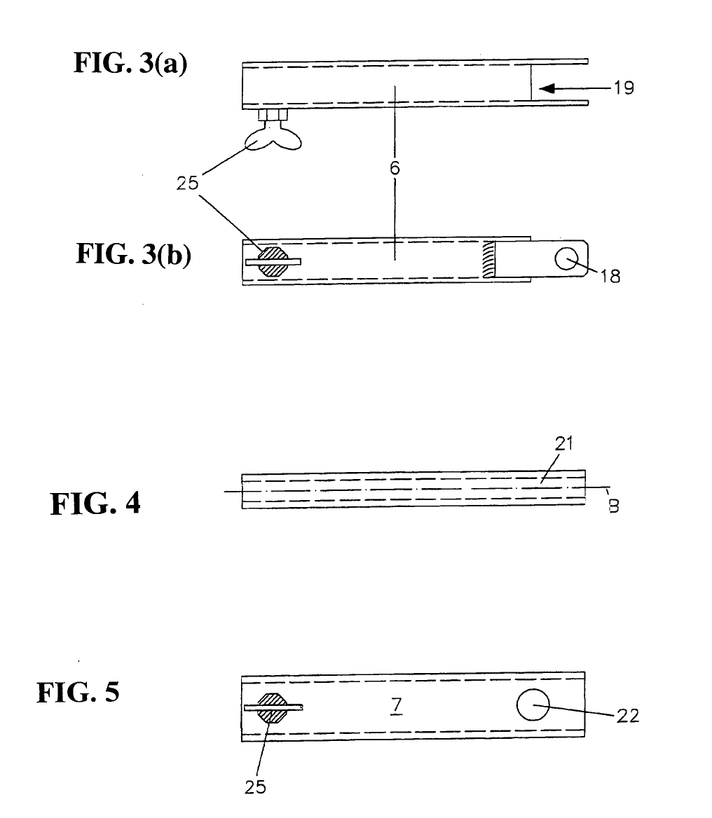

FIG. 3 schematic representations of

a) an enlarged side view of a detail from FIG. 1, relating to the first section of the holding arm, and

b) an enlarged bottom view of a detail from FIG. 1, relating to the first section of the holding arm,

FIG. 4 a schematic representation of an enlarged side view of a detail from FIG. 1, relating to the internal part between the first and second sections of the holding arm,

FIG. 5 a schematic representation of an enlarged bottom view of a detail from FIG. 1, relating to the second section of the holding arm,

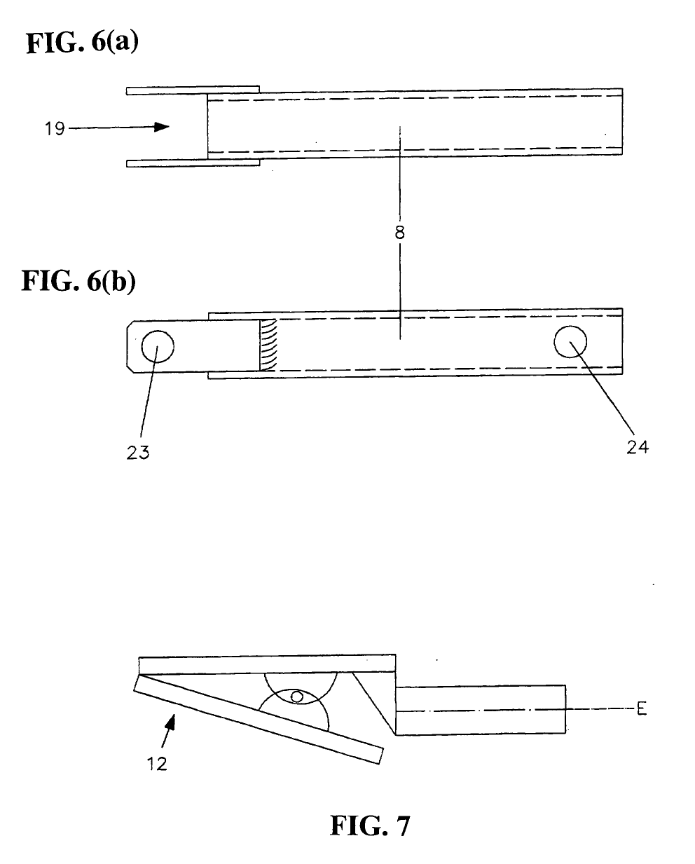

FIG. 6 schematic representations of

a) an enlarged side view of a detail from FIG. 1, relating to the third section of the holding arm, and

b) an enlarged bottom view of a detail from FIG. 1, relating to the third section of the holding arm,

FIG. 7 a schematic representation of an enlarged side view of a detail from FIG. 1, relating to the fastening means on the fourth section of the holding arm, and

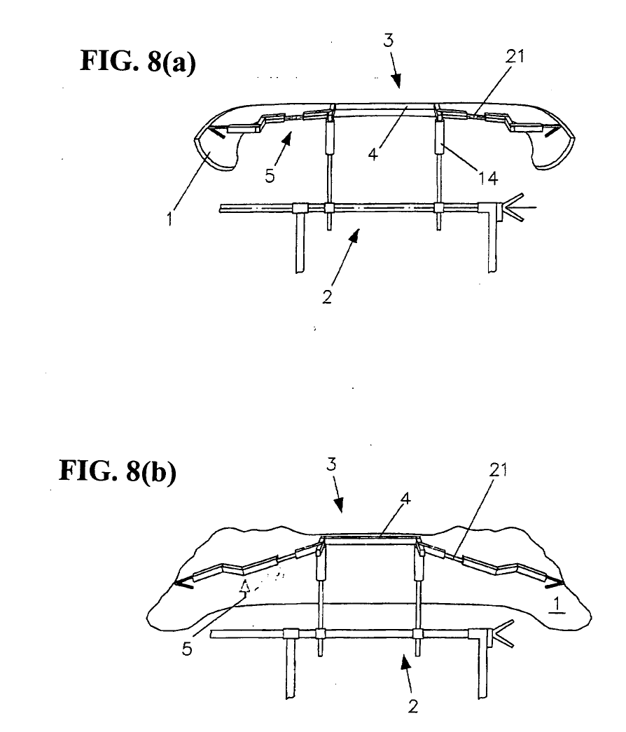

FIG. 8 schematic perspective representations, at reduced scale, of the subject matter of FIG. 1 in application with

a) an impact bar of a motor vehicle, and

b) a rear bumper of a motor vehicle.

FIGS. 1, 8a, and 8b show the inventive device for holding components 1, shown here in FIG. 8a as an impact bar, and in FIG. 8b as a rear bumper of a motor vehicle. The inventive device is used for the purpose of painting the component 1, including steps such as priming, filling, and sanding. The device has a frame 2 with holding means on the top. The holding means are comprised of a supporting part 3 with a cantilever structure 4 and two projecting holding arms 5.

According to the invention, the holding arms 5 have sections 6 through 9 that are connected to one another in an articulated and/or rotatable manner. It is evident from FIGS. 8a and 8b that the component 1 in the operating position is supported on the free end of the cantilever structure 4 and on the holding arms 4, and is also secured there.

It is evident from FIGS. 1, 8a, and 8b, and especially from FIG. 2b, that the cantilever structure 4 is essentially U-shaped in top view, with the base part 10 of the U-shaped cantilever structure 4 being longer than its arms 11. FIG. 1 shows that two fastening means are provided a distance apart from one another on the base part 10 in the form of movably and rotatably mounted holding vises 12, in order to attach the component 1. Mounting of the holding vises 12 to the base part 10 is accomplished with known means which are not shown in detail and which permit their locking.

The supporting part 3 is detachably connected to a cross-member 13, which can rotate in the direction of the arrow F, of the frame 2, in that receptacles 14 of the supporting part 3 form a plug-in connection with mounts 15 of the cross-member 13. A handle 16 is provided for rotating the cross-member 13. Because it is known, the mounting of the cross-member 13 is merely indicated in the drawing here, and is not given a reference character.

The cantilever structure 4 extends at right angles to the receptacles 14, and here is welded to them. The cantilever structure 4 consists—as shown in FIG. 2a—of square tubing, here with the dimensions 20×20 mm. The base part 10 has a length of 500 mm, the arms 11 are 180 mm long. The receptacles 14 are made of round tubing with a diameter of approximately 35 mm.

The holding arms 5 are arranged on the cantilever structure 4, namely on the relevant arm 11. In FIG. 2b, a bore 17 is indicated by a dashed line; this bore is located on the underside of the arm 11, approximately in the first third of the arm 11 adjacent to the base part 10. The bore 18 of the link joint 19 of the first section 6 of the holding arm 5 shown in FIGS. 3a, 3b, is brought into alignment with the bore 17 of the arm 11 and, while the link joint 19 engages around the arm 11, is secured with a wing screw 20. The wing screw 20 providing the connection between the arm 11 and the first section 6 is partially visible in FIG. 1. A slight loosening of the wing screw 20 permits pivoting or rotation of the first section 6 about an axis of rotation A perpendicular to the arm 11. Tightening the wing screw 20 locks the first section 6 of the holding arm 5 in the desired angular position. The arrangement of the wing screw 20 in question on the underside of the cantilever structure 4 and also on the undersides of the holding arms 5 has the advantage that the paint does not stick the threads together.

A holding arm 5 has four tubular sections 6 through 9, which are telescoping and/or rotatable.

Adjoining the first section 6 of the holding arm 5 articulated to the arm 11 of the cantilever structure 4 is a second section 7, which is connected to the first section 6 through an internal part 21 in the form of a round tube shown in FIG. 4. One end of the internal part 21 projects into the first section 6 and the other end projects into the second section 7, permitting length adjustment or telescoping due to the ability to move relative to the two sections 6, 7. The zero position, in which the internal part 21 is located entirely inside the two sections 6, 7, is shown in FIG. 1. An extended position is shown in FIGS. 8a and 8b.

The internal part 21 can be secured through the wing screw 25 of the first section 6 and/or of the second section 7, shown in FIGS. 3a, 3b and 5 and fastened by means of a weld nut. Rotation of the second section 7 about the longitudinal axis B of the internal part 21 can take place, for example, when the internal part 21 is secured by the wing screw 25 of the first section 6. However, rotation about the longitudinal axis B can also take place by the means that the internal part 21 and the second section 7 are connected by the wing screw 25 of the second section 7 and are rotated together. Once the angular position has been set, the internal part 21 can be locked in the first section 6 by the wing screw 25 located there.

The bore 22 of the second section 7 shown in FIG. 5 has the same function as the bore 17 of the arm 11 of the cantilever structure 4. The bore 23 of the link joint 19 of the third section 8 of the holding arm 5 is brought into alignment with the bore 22 of the second section 7, and the sections 7, 8 are locked in the desired angular position by means of wing screw 20. The third section 8 of the holding arm 5 is rotatable about an axis of rotation C perpendicular to the second section 7.

The bore 24 of the third section 8 shown in FIG. 6b again has the same function as the bore 17 of the arm 11 of the cantilever structure 4 and the bore 22 of the second section 7, and serves to connect to the link joint 19 of the fourth section 9 of the holding arm 5. The fourth section 9 can pivot about an axis of rotation D perpendicular to the third section 8 and can be locked in a desired angular position by means of the wing screw 20. Located at the free end of the fourth section 9 of the holding arm 5 is a holding vise 12. The holding vise 12, shown especially clearly in FIG. 7, with a spring mechanism (not labeled) and clamping region, is arranged to be rotatable in the fourth section 9 about its longitudinal axis E.

Like the cantilever structure 4, the sections 6 through 9 of the holding arms 5 are also made of square tubing.

It is evident from FIGS. 8a and 8b that the inventive device can be adapted to a variety of components 1 because of the adjustability of the various sections 6 through 9 of the holding arms 5. As a result of the statically favorable angular position of the individual sections 6 through 9 of the holding arms 5, and as a result of the cantilever structure 4, high stability is achieved, which, in addition to application of paint, permits other mechanically demanding steps such as sanding, filling and priming with ergonomically healthy postures of the personnel and high stability of the device. Deformation of the component 1 is prevented with proper use of the device. In the example applications shown in FIGS. 8a and 8b, the component 1 rests on the cantilever structure 4. The holding vises 12 can be added there.

With regard to additional features not shown in the figures, please refer to the general portion of the description.

In conclusion, it must be noted that the inventive teaching is not limited to the example application discussed above. Rather, an extremely wide variety of embodiments of the device are possible with regard to the cantilever structure, the holding arms, and connecting methods. Nor are the areas of application of the invention limited to the automotive industry; applications in the construction industry are also possible. The inventive device can be used to hold, for example, window frames, posts, fence pickets, and similar components.

### LIST OF REFERENCE CHARACTERS

1 component

2 frame

3 supporting part

4 cantilever structure

5 holding arm

6 first section of 5

7 second section of 5

8 third section of 5

9 fourth section of 5

10 base part of 4

11 arm of 4

12 holding vise

13 cross-member of 2

14 receptacle of 3

15 mount of 13

16 handle on 13

17 bore for 19 in 6

18 bore in 6

19 link joint

20 wing screw

21 internal part

22 bore for 19 in 8

23 bore in 8

24 bore for 19 in 9

25 wing screw of 6, 7 for 21

A axis of rotation of 6

B longitudinal axis of 21

C axis of rotation of 8

D axis of rotation of 9

E longitudinal axis of 12

F direction of rotation of 13

1. Device for holding components (1), particularly bumpers and impact bars of motor vehicles, particularly for the purpose of painting, having a frame (2), wherein the frame (2) includes holding means on the top side with a supporting part (3), with a cantilever structure (4) and two holding arms (5) projecting therefrom, characterized in that the holding arms (5) have sections (6 through 9) that are articulated and/or are rotatably connected to one another, and in that the component (1) in the operating position is supported on the free end of the cantilever structure (4) and on the holding arms (5).

2. Device according to claim 1, characterized in that the component is secured to the holding arms (5) and/or to the free end of the cantilever structure (4).

3. Device according to claim 1 or 2, characterized in that the cantilever structure (4) has essentially a U-shape viewed from above.

4. Device according to claim 3, characterized in that the base part (10) of the U-shaped cantilever structure (4) is longer than the arms (11) of the U-shape, and preferably has fastening means, in particular at least one holding vise (12).

5. Device according to one of claims 1 through 4, characterized in that the supporting part (3) is attachable in a releasable manner to a preferably rotatable cross-member (13) of the frame (2), and, in particular, a plug-in connection can be formed by means of receptacles (14) on the supporting part (3) and mounts (15) on the cross-member (13).

6. Device according to claim 5, characterized in that the cantilever structure (4) extends perpendicular to the receptacles (14) and is detachably connected thereto.

7. Device according to one of claims 1 through 6, characterized in that the holding arms (5) are located on the cantilever structure (4), with, in particular, one holding arm (5) in each case being associated with one arm (11) of the essentially U-shaped cantilever structure (4).

8. Device according to one of claims 1 through 7, characterized in that a holding arm (5) comprises four tubular sections (6 through 9), and in that preferably at least one section (6 through 9) of the holding arm (5) is telescoping and/or rotatable.

9. Device according to claim 8, characterized in that the first section (6) of the holding arm (5) is articulated to the cantilever structure (5) [sic], in particular to the arm (11) of the essentially U-shaped cantilever structure (4), and is rotatable about an axis of rotation (A) perpendicular to the arm (11), and can be locked in a desired angular position.

10. Device according to claim 8 or 9, characterized in that the second section (7) of the holding arm (5) is connected to the first section (6) through an internal part (21), preferably in the form of a round tube.

11. Device according to claim 10, characterized in that one end of the internal part (21) projects into the first section (6) and the other end projects into the second section (7), and in that the internal part (21) permits a length adjustment through movability relative to the two sections (6, 7) between a zero position, wherein the internal part (21) is located completely within the two sections (6, 7), and a maximum position.

12. Device according to claim 10 or 11, characterized in that the internal part (2 1) and/or the second section (7) is or are rotatable about the longitudinal axis (B) and can be locked in a desired angular position.

13. Device according to one of claims 8 through 12, characterized in that the third section (8) of the holding arm (5) is articulated to the second section (7) at the end opposite the first section (6), is rotatable about an axis of rotation (C) perpendicular to the second section (7), and can be locked in a desired angular position.

14. Device according to one of claims 8 through 13, characterized in that the fourth section (9) of the holding arm (5) is articulated to the third section (8) at the end opposite the second section (7), is rotatable about an axis of rotation (D) perpendicular to the third section (8), and can be locked in a desired angular position.

15. Device according to one of claims 8 through 14, characterized in that the fourth section (9) of the holding arm (5) has, at the free end opposite the third section (8), fastening means, in particular a holding vise (12), which is arranged in the fourth section (9) to be rotatable about its longitudinal axis (E) and preferably can be locked in a desired angular position.

16. Device according to one of claims 1 through 15, characterized in that link joints (19) are provided for the articulated connections of the sections (6 through 9) of the holding arms (5), and in that the axes of rotation (A, C, D) are formed by wing screws (20) that constitute locking means at the same time.

17. Device according to one of claims 1 through 16, characterized in that the cantilever structure (4) and the sections (6 through 9) of the holding arms are made of square tubing.

18. Device according to one of claims 1 through 17, characterized in that the supporting part (3), in particular the receptacles (14), the cantilever structure (4), and the holding arms (5), and if applicable also their individual sections (6 through 9), and if applicable the fastening means, are parts of a kit.
